(19) United States
(12) Patent Application Publication
(10) Pub. No.: US 2015/0261246 A1
(43) Pub. Date: Sep. 17, 2015

(54) REFERENCE VOLTAGE GENERATOR SYSTEM

(71) Applicant: TEXAS INSTRUMENTS INCORPORATED, Dallas, TX (US)

(72) Inventor: JERRY L. DOORENBOS, Tucson, AZ (US)

(21) Appl. No.: 14/644,788

(22) Filed: Mar. 11, 2015

Related U.S. Application Data
(60) Provisional application No. 61/951,300, filed on Mar. 11, 2014.

(51) Int. Cl. G05F 3/02

(52) U.S. Cl. CPC G05F 3/02

(57) ABSTRACT

One example includes an reference voltage generator system. The system includes an amplifier configured to generate a reference voltage based on a respective input voltage provided at each of at least one input of the amplifier. The system also includes at least one input transistor that is coupled to the at least one input of the amplifier and is statically-biased to conduct a current to set an amplitude of the respective input voltage provided at each of the at least one input of the amplifier. Each of the at least one input transistor includes an input terminal that is coupled in series with an input resistor.

### CROSS-REFERENCE TO RELATED APPLICATION

This application claims the benefit of U.S. Provisional Patent Application No. 61/951,300, filed Mar. 11, 2014, and entitled “METHOD FOR FLICKER AND BURST NOISE REDUCTION AND BASE CURRENT CORRECTION IN BAND GAP REFERENCE CIRCUIT”, which is incorporated herein by reference in its entirety.

### TECHNICAL FIELD

This disclosure relates to a reference voltage generator system.

### BACKGROUND

Amplifier circuits can be implemented in a variety of applications. One example is a reference voltage generator system (e.g., a bandgap reference voltage system) that can be implemented to generate a substantially stable reference voltage for a variety of circuit applications. Reference voltage generator systems can typically implement an arrangement of transistors and/or resistors to set an input voltage at an amplifier, with the amplifier generating the reference voltage. For example, reference voltage generator systems can be configured in a variety of processes, such as complementary metal-oxide semiconductor (CMOS) processes, and can include optimized arrangements of transistors and resistors. However, resistors that are implemented to set the input voltage for the amplifier can typically contribute to thermal noise in the generation of the reference voltage. Similarly, the transistors can likewise contribute to a number of noise sources, such as thermal noise, shot noise, flicker noise, and/or burst noise. Such noise sources can contribute to a degradation of stability of the reference voltage.

### SUMMARY

One example includes a reference voltage generator system. The system includes an amplifier configured to generate a reference voltage based on a respective input voltage provided at each of at least one input of the amplifier. The system also includes at least one input transistor that is coupled to the at least one input of the amplifier and is statically-biased to conduct a current to set an amplitude of the respective input voltage provided at each of the at least one input of the amplifier. Each of the at least one input transistor includes an input terminal that is coupled in series with an input resistor.

Another example includes a circuit. The circuit includes an amplifier configured to generate a reference voltage based on a respective input voltage provided at each of at least one input of the amplifier. The circuit further includes at least one input transistor that is coupled to the at least one input of the amplifier and is statically-biased to conduct a current to set an amplitude of the respective input voltage provided at each of the at least one input of the amplifier. Each of the at least one input transistor includes an input terminal that is coupled in series with an input resistor. The input resistor can have a resistance value that is selected based on an error term of a current associated with the input terminal of the respective at least one transistor. The current associated with the input terminal can be associated with an activation voltage of the at least one transistor to set the amplitude of the respective input voltage.

Another example includes amplifier reference voltage generator system. The system includes an amplifier configured to generate a reference voltage based on a respective input voltage provided at each of at least one input of the amplifier. The system also includes at least one input bipolar junction transistor (BJT) that is coupled to the at least one input of the amplifier and is statically-biased to conduct a current to set an amplitude of the respective input voltage provided at each of the at least one input of the amplifier. Each of the at least one input BJT includes an input resistor interconnecting a base and a collector of the respective at least one input BJT. The system further includes at least one feedback circuit component associated with a feedback arrangement of the amplifier to set the amplitude of the at least one input voltage. The at least one feedback circuit component can be fabricated as a matched component of the at least one input resistor or of an output transistor that is controlled via the amplifier, such that the reference voltage is approximately insensitive to temperature variation.

### BRIEF DESCRIPTION OF THE DRAWINGS

FIG. 1 illustrates an example of a reference voltage generator system.

FIG. 2 illustrates an example of a reference voltage generator circuit.

FIG. 3 illustrates another example of a reference voltage generator circuit.

FIG. 4 illustrates yet another example of a reference voltage generator circuit.

FIG. 5 illustrates yet a further example of a reference voltage generator circuit.

### DETAILED DESCRIPTION

This disclosure relates generally to electronic circuits, and more specifically to a reference voltage generator system. The circuit system can include an amplifier configured to generate a reference voltage based on a feedback arrangement based on at least one input voltage at an input of the amplifier. Additionally, the reference voltage generator system can include an arrangement of resistors and input transistors, such as bipolar junction transistors (BJTs), that can be implemented to set an amplitude of the input voltage(s) at the input of the amplifier. As an example, the input transistors can be statically biased, such as based on being diode-connected. Additionally, to provide an amplitude of the reference voltage that is substantially stable, such as based on mitigation of noise sources (e.g., thermal noise, burst noise, and/or flicker noise), the input transistors can include an input resistor coupled in series at an input terminal (e.g., a base) of the respective input transistor to mitigate errors associated with the respective noise sources.

For example, the input resistor can have a resistance value that is selected based on an error term associated with an input current (e.g., base current) of the respective input transistor. The input current can be associated with an activation voltage of the input transistor(s) that sets the amplitude of the respective input voltage of the amplifier. Therefore, the resistance value of the resistor can be selected to mitigate the error term, such that the activation voltage of the input transistor can be substantially more stable to provide a respective voltage across the input transistor(s) that can likewise be substantially more stable. Accordingly, the reference voltage generated by the amplifier can be generated at a substantially more stable amplitude. The reference voltage generator system can be implemented in a variety of ways, such as based on a variety of feedback arrangements and/or arrangements of the input transistor(s).

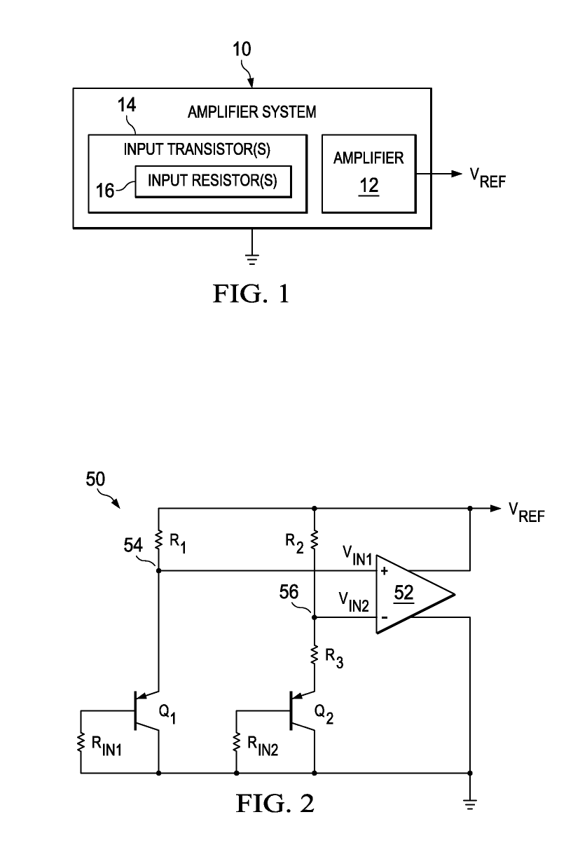

FIG. 1 illustrates an example of an reference voltage generator system 10. The reference voltage generator system 10 can be implemented as a reference voltage generator system, such as implemented in a variety of circuit applications (e.g., as a bandgap voltage generator) to generate a substantially stable reference voltage V_{REF}. As an example, the reference voltage generator system 10 can be formed as or as part of an integrated circuit (IC) chip. The reference voltage generator system 10 includes an amplifier 12 (e.g., an operational amplifier (OP-AMP)) that is configured to generate the reference voltage V_{REF} at an output based on an input voltage provided to at least one input of the amplifier 12. The input voltage can be set based on a feedback arrangement of the amplifier 12 in a variety of ways. Additionally, the reference voltage generator system 10 includes at least one input transistor 14 that is likewise configured to set an amplitude of the input voltage at the respective input(s) of the amplifier 12. As described herein, the term “transistor” describes one or more transistor devices arranged to function as a transistor. For example, each of the input transistor(s) 14 can be arranged as a bipolar junction transistor (BJT) that is diode-connected based on having a base coupled to a collector (e.g., via an interconnecting input resistor, as described in greater detail herein), and is thus statically biased. As described herein, the term “statically biased” refers to an arrangement of the input transistor(s) 14 in which the activation of respective input transistor(s) 14 is unaffected by dynamic external signals, and is thus configured to maintain a substantially consistent activation to maintain a substantially stable and static current flow through the respective input transistor(s) 14, and thus a substantially stable and static resistance across the respective input transistor(s) 14. One example of a statically biased transistor is a diode-connected transistor. As used herein, the term “substantially” is intended to convey that although an effect or result is intended, in practice, there may be a small amount of variation, such as due to component tolerances and/or processing variations. As described herein, the reference voltage generator system 10 can be arranged in a variety of ways with respect to the feedback arrangement of the amplifier 12 and the input transistor(s) 14.

In the example of FIG. 1, each of the input transistor(s) 14 includes an input resistor 16 that is coupled in series with an input terminal of the respective input transistor(s) 14. As described herein, the term “resistor” refers to one or more resistive elements that provide a collective resistance. For example, the input resistor 16 can be coupled in series with a base of the input transistor(s) 14 that are configured as BJT(s), such as based on interconnecting the base and the collector of the diode-connected input transistor(s) 14. As an example, the input resistor 16 of each of the input transistor(s) 14 can have a resistance value that is selected based on an error term associated with an input current (e.g., base current) of the respective input transistor(s) 14. The input current can be associated with an activation voltage of the input transistor(s) 14 that sets the amplitude of the respective input voltage of the amplifier 12. Therefore, the resistance value of the resistor can be selected to mitigate the error term, such that the activation voltage of the input transistor can be substantially more stable to provide a respective voltage across the input transistor(s) 14 that can likewise be substantially more stable, such as based on mitigating sources of noise, such as thermal noise, flicker noise, and/or burst noise.

FIG. 2 illustrates an example of a reference voltage generator circuit 50. The reference voltage generator circuit 50 can correspond to the reference voltage generator system 10, and is thus demonstrated as a first example of the reference voltage generator system 10.

The reference voltage generator circuit 50 includes an amplifier 52 arranged as an OP-AMP that is configured to generate the reference voltage V_{REF} with reference to a low-voltage rail, demonstrated in the example of FIG. 2 as ground. The amplifier 52 receives a first input voltage V_{IN1} on a node 54 at a non-inverting input and a second input voltage V_{IN2} on a node 56 at an inverting input. The node 54 is arranged between a resistor R₁ and an emitter of a first input transistor Q₁, demonstrated in the example of FIG. 2 as a PNP-type BJT. The node 56 is arranged between a resistor R₂ and a resistor R₃, with the resistor R₃ interconnecting the node 56 and an emitter of a second input transistor Q₂, demonstrated in the example of FIG. 2 as a PNP-type BJT. The input transistors Q₁ and Q₂ each have collectors that are coupled to the low-voltage rail. As an example, the input transistors Q₁ and Q₂ can be substrate-coupled BJTs based on having a collector that is coupled to or forms a substrate of an associated IC chip, and can have sizes that differ with respect to each other to achieve a desired gain of the reference voltage V_{REF}. The resistors R₁ and R₂ interconnect the reference voltage V_{REF} and the respective nodes 54 and 56. Therefore, the amplifier 52 is demonstrated in the example of FIG. 2 in a feedback arrangement, such that the reference voltage V_{REF} provided at an output of the amplifier 52 is implemented to set the input voltages V_{IN1} and V_{IN2} at the respective inputs of the amplifier 52.

As an example, the reference voltage V_{REF} can be generated as a bandgap voltage based on a summation of a V_{be} voltage and a scaled difference of the V_{be} voltages of the input transistors Q₁ and Q₂. The V_{be} voltage can have a negative variation with increasing temperature, and the difference between the two V_{be} voltages can have a positive variation with increasing temperature (e.g., proportional-to-absolute-temperature (PTAT)). Appropriate scaling of the difference between the two V_{be} voltages of the input transistors Q₁ and Q₂ relative to the V_{be} voltage in the summation can result in a substantially zero variation with respect to temperature variation. The difference in the V_{be} voltages can be generated by choosing static biasing currents in the input transistors Q₁ and Q₂, such as to provide a constant ratio between operating current densities of the input transistors Q₁ and Q₂. For example, the constant ratio can be accomplished based on same magnitude bias currents in both of the input transistors Q₁ and Q₂ with one of the input transistors Q₁ and Q₂ having larger area than the other, both of the input transistors Q₁ and Q₂ having the same size but with a fixed ratio of bias current, or a combination thereof.

In the example of FIG. 2, the input transistors Q₁ and Q₂ are each demonstrated as diode-connected, such that the base of each of the input transistors Q₁ and Q₂ are coupled to the collector of each of the input transistors Q₁ and Q₂ at the low-voltage rail. Therefore, the input transistors Q₁ and Q₂ are statically biased to provide a substantially static activation of the respective Q₁ and Q₂ to provide current flow through the input transistors Q₁ and Q₂. Additionally, in the example of FIG. 2, the input transistor Q₁ includes an input resistor R_{IN1} that is coupled in series with the base to interconnect the base and the collector of the input transistor Q₁. Similarly, the input transistor Q₂ includes an input resistor R_{IN2} that is coupled in series with the base to interconnect the base and the collector of the input transistor Q₂. Therefore, the diode-connection of the input transistors Q₁ and Q₂ is via the respective input resistors R_{IN1} and R_{IN2}.

The amplitude of the input voltages V_{IN1} and V_{IN2} can thus depend on the resistance in series with the respective input transistors Q₁ and Q₂ the voltage across the input resistors R_{IN1} and R_{IN2}, and the respective activation of the input transistors Q₁ and Q₂ to provide a current flow through the respective input transistors Q₁ and Q₂. The activation of the input transistors Q₁ and Q₂ is based on a emitter-base voltage V_{eb} of the respective input transistors Q₁ and Q₂, defined as:

$$\begin{matrix}{V}_{eb} = {V}_{T} ln [ \frac{{I}_{e} - {I}_{b}}{{I}_{s}} ] & Equation 1 \\ {V}_{eb} = {V}_{T} ln [ ( \frac{{I}_{e}}{{I}_{s}} ) ( 1 - \frac{{I}_{b}}{{I}_{e}} ) ] = {V}_{T} [ ln ( \frac{{I}_{e}}{{I}_{s}} ) + ln ( 1 - \frac{{I}_{b}}{{I}_{e}} ) ] & Equation 2\end{matrix}$$

Where:
V_{T} is a thermal voltage defined by k*T/q;
Iₑ is an emitter current of the respective input transistor;
I_{b} is a base current of the respective input transistor;
I_{c} is a collector current of the respective input transistor; and
Iₛ is a saturation current of the respective input transistor.
   As demonstrated in Equation 2, the emitter-base voltage V_{eb} includes an error term associated with the base current I_{b} based on the emitter-base voltage V_{eb} being a function of the emitter current Iₑ and the saturation current Iₛ. As a result, with the input resistors R_{IN1} and R_{IN2} being coupled in series with the base of the respective input transistors Q₁ and Q₂, the respective resistance value of the input resistors R_{IN1} and R_{IN2} can be selected based on the base current I_{b} to calculate a sum of the emitter-base voltage V_{eb} and the voltage drop of the respective one of the input resistors R_{IN1} and R_{IN2} to achieve an emitter-base voltage V_{eb} that is a function of the emitter current Iₑ and the saturation current Iₛ, as follows:

$$\begin{matrix}{R}_{b} = \frac{- {V}_{T} ln [ 1 - \frac{{I}_{b}}{{I}_{e}} ]}{{I}_{b}} & Equation 3 \\ {V}_{ebr} = {V}_{eb} + {I}_{b} {R}_{b} = {V}_{T} ln [ \frac{{I}_{e}}{{I}_{s}} ] + {V}_{T} ln [ 1 - \frac{{I}_{b}}{{I}_{e}} ] - \frac{{I}_{b} {V}_{T} ln [ 1 - \frac{{I}_{b}}{{I}_{e}} ]}{{I}_{b}} = {V}_{T} ln [ \frac{{I}_{e}}{{I}_{s}} ] & Equation 4\end{matrix}$$

By implementing the input resistors R_{IN1} and R_{IN2} in series with the base of the respective input transistors Q₁ and Q₂, the reference voltage generator circuit 50 can compensate for errors based on controlling the emitter current Iₑ instead of the collector current I_{c}. Since the error term associated with the base current I_{b} in the calculation of the emitter-base voltage V_{eb} can contribute to error effects based on transistor β, base current shot noise, flicker noise, and/or burst noise, the error effects can be substantially mitigated based on controlling the emitter current Iₑ instead of the collector current I_{c} in response to implementing the input resistors R_{IN1} and R_{IN2}. Accordingly, the inclusion of the input resistors R_{IN1} and R_{IN2} in the reference voltage generator circuit 50 can substantially mitigate noise (e.g., low-frequency noise) in the reference voltage V_{REF}, resulting in a more stable reference voltage V_{REF}.

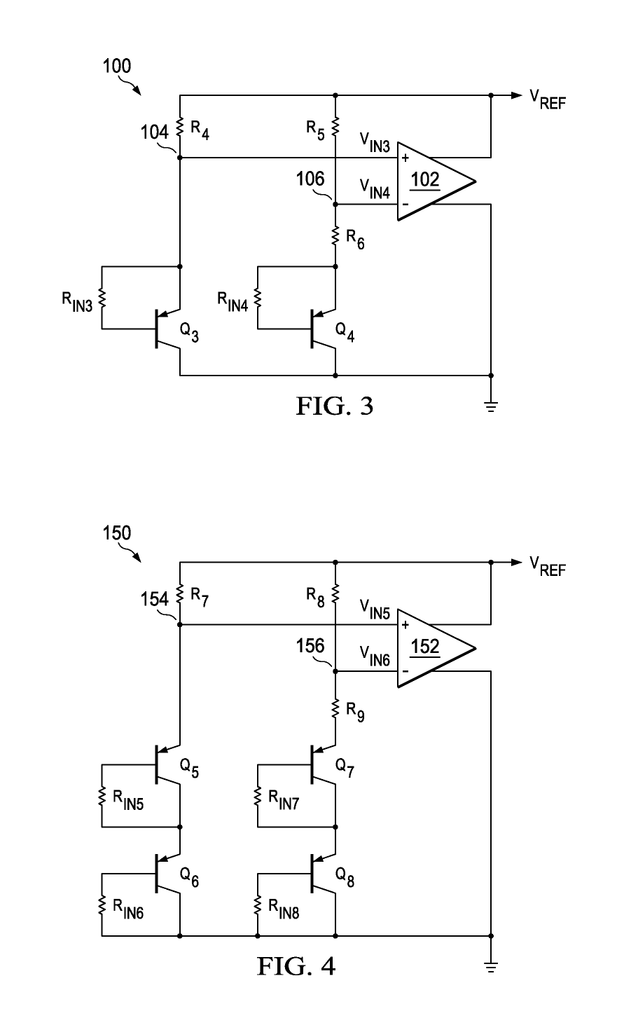

It is to be understood that the implementation of the resistors R_{IN1} and R_{IN2} can be sufficient to substantially mitigate noise (e.g., low-frequency noise) over a large variation of transistor β associated with the input transistors Q₁ and Q₂, particularly with larger values of transistor β. Additionally, the emitter current Iₑ of the input transistors Q₁ and Q₂ can be set to be proportional-to-absolute-temperature (PTAT). Additionally, the input resistors R_{IN1} and R_{IN2} can be fabricated as the same type of resistors as the resistors R₁, R₂, and R₃, and thus fabricated as matched components, such that the input resistors R_{IN1} and R_{IN2} and the resistors R₁, R₂, and R₃ can have approximately equal temperature coefficients. For example, the difference between the V_{be} voltages of the input transistors Q₁ and Q₂ is across the resistor R₃ coupled between the input transistor Q₂ and the node 56 since the feedback configuration of the amplifier 52 can result in a very near zero voltage difference between the two inputs of the amplifier 52. The difference in the V_{be} voltages can be scaled by the voltage divider formed by the resistors R₂ and R₃ such that the reference voltage V_{REF} can be substantially constant with temperature. The resistor R₁ interconnecting the reference voltage V_{REF} and the input transistor Q₁ can cause the current flow in the input transistors Q₁ and Q₂ to be approximately equal or to be scaled by the resistor ratio. As an example, the input transistors Q₁ and Q₂ can be scaled in size to generate the V_{be} voltage difference. The biasing of the input transistors Q₁ and Q₂ can be set by a difference between the V_{be} voltages impressed across a resistor (e.g., the resistor R₆ in FIG. 3) resulting in a PTAT/R current.

Additionally, the resistors R₁, R₂, and R₃ can be appropriately scaled in resistance value with respect to each other to provide a substantially constant amplitude of the reference voltage V_{REF} with respect to temperature. Therefore, the emitter current Iₑ can be provided in a PTAT/R manner, such that an effective resistance value of the respective input resistors R_{IN1} and R_{IN2} can be substantially constant as a function of temperature.

Furthermore, it is to be understood that the reference voltage generator circuit 50 is not limited to as demonstrated in the example of FIG. 2. For example, the feedback arrangement of the amplifier 52 is not limited to the use of the resistors R₁, R₂, and R₃, such as described in greater detail herein, but could implement a variety of other ways to generate the reference voltage V_{REF} in the feedback arrangement. Additionally, the input transistors Q₁ and Q₂ can be implemented as NPN-type transistors instead of PNP-type transistors, as demonstrated in the example of FIG. 3.

FIG. 3 illustrates another example of a reference voltage generator circuit 100. The reference voltage generator circuit 100 can correspond to the reference voltage generator system 10, and is thus demonstrated as a second example of the reference voltage generator system 10.

The reference voltage generator circuit 100 includes an amplifier 102 arranged as an OP-AMP that is configured to generate the reference voltage V_{REF} with reference to a low-voltage rail, demonstrated in the example of FIG. 3 as ground. The amplifier 102 receives a first input voltage V_{IN3} on a node 104 at a non-inverting input and a second input voltage V_{IN4} on a node 106 at an inverting input. The node 104 is arranged between a resistor R₄ and a collector of a first input transistor Q₃, demonstrated in the example of FIG. 3 as an NPN-type BJT. The node 106 is arranged between a resistor R₅ and a resistor R₆, with the resistor R₆ interconnecting the node 106 and a collector of a second input transistor Q₄, demonstrated in the example of FIG. 3 as an NPN-type BJT. The input transistors Q₃ and Q₄ each have emitters that are coupled to the low-voltage rail. As an example, the input transistors Q₃ and Q₄ can have sizes that differ with respect to each other to achieve a desired gain of the reference voltage V_{REF}. The resistors R₄ and R₅ interconnect the reference voltage V_{REF} and the respective nodes 104 and 106. Therefore, the amplifier 102 is demonstrated in the example of FIG. 3 in a feedback arrangement, such that the reference voltage V_{REF} provided at an output of the amplifier 102 is implemented to set the input voltages V_{IN3} and V_{IN4} at the respective inputs of the amplifier 102.

In the example of FIG. 3, the input transistors Q₃ and Q₄ are each demonstrated as diode-connected, such that the base of each of the input transistors Q₃ and Q₄ are coupled to the collector of each of the input transistors Q₃ and Q₄. Therefore, the input transistors Q₃ and Q₄ are statically biased to provide a substantially static activation of the respective Q₃ and Q₄ to provide current flow through the input transistors Q₃ and Q₄. Additionally, in the example of FIG. 3, the input transistor Q₃ includes an input resistor R_{IN3} that is coupled in series with the base to interconnect the base and the collector of the input transistor Q₃. Similarly, the input transistor Q₄ includes an input resistor R_{IN4} that is coupled in series with the base to interconnect the base and the collector of the input transistor Q₄. Therefore, the diode-connection of the input transistors Q₃ and Q₄ is via the respective input resistors R_{IN3} and R_{IN4}.

Similar to as described previously regarding the example of FIG. 2, based on the input resistors R_{IN3} and R_{IN4} being coupled in series with the base of the respective input transistors Q₃ and Q₄, the reference voltage generator circuit 100 can compensate for errors based on controlling the emitter current Iₑ instead of the collector current I_{c}. For example, a base-emitter voltage V_{be} can be controlled based on the emitter current Iₑ instead of the collector current I_{c}, such as demonstrated in Equations 2-4. Since the error term associated with the base current I_{b} in the calculation of the base-emitter voltage V_{be} can contribute to error effects based on transistor β, base current shot noise, flicker noise, and/or burst noise, the error effects can be substantially mitigated based on controlling the emitter current Iₑ instead of the collector current I_{c} in response to implementing the input resistors R_{IN3} and R_{IN4}. Accordingly, the inclusion of the input resistors R_{IN3} and R_{IN4} in the reference voltage generator circuit 100 can substantially mitigate low frequency noise in the reference voltage V_{REF}, resulting in a more stable reference voltage V_{REF}.

FIG. 4 illustrates yet another example of a reference voltage generator circuit 150. The reference voltage generator circuit 150 can correspond to the reference voltage generator system 10, and is thus demonstrated as a third example of the reference voltage generator system 10.

The reference voltage generator circuit 150 includes an amplifier 152 arranged as an OP-AMP that is configured to generate the reference voltage V_{REF} with reference to a low-voltage rail, demonstrated in the example of FIG. 4 as ground. The amplifier 152 receives a first input voltage V_{IN5} on a node 154 at a non-inverting input and a second input voltage V_{IN6} on a node 156 at an inverting input. The node 154 is arranged between a resistor R₇ and an emitter of a first input transistor Q₅ that is coupled in series with a second input transistor Q₆. The node 156 is arranged between a resistor R₈ and a resistor R₉, with the resistor R₉ interconnecting the node 156 and an emitter of a third input transistor Q₇ that is coupled in series with a fourth input transistor Q₈. In the example of FIG. 4, the input transistors Q₅, Q₆, Q₇, and Q₈ are each demonstrated in the example of FIG. 4 as PNP-type BJTs. The input transistors Q₆ and Q₈ each have collectors that are coupled to the low-voltage rail. As an example, the input transistors Q₆ and Q₈ can be substrate-coupled BJTs, and the input transistors Q₅ and Q₆ can have sizes that differ with respect to the input transistors Q₇ and Q₈ to achieve a desired gain of the reference voltage V_{REF}. The resistors R₇ and R₈ interconnect the reference voltage V_{REF} and the respective nodes 154 and 156. Therefore, the series-connected input transistors Q₅ and Q₆ can set an amplitude of the input voltage V_{IN5} based on the current flow of the input transistors Q₅ and Q₆ along with the resistor R₇. Similarly, the series-connected input transistors Q₇ and Q₈ can set an amplitude of the input voltage V_{IN6} based on the current flow of the input transistors Q₇ and Q₈ along with the resistors R₈ and R₉. Therefore, the amplifier 152 is demonstrated in the example of FIG. 4 in a feedback arrangement similar to the examples of FIGS. 2 and 3.

In the example of FIG. 4, the input transistors Q₅, Q₆, Q₇, and Q₈ are each demonstrated as diode-connected, such that the base of each of the input transistors Q₅, Q₆, Q₇, and Q₈ are coupled to the collector of each of the input transistors Q₅, Q₆, Q₇, and Q₈. Therefore, the input transistors Q₅, Q₆, Q₇, and Q₈ are statically biased to provide a substantially static activation of the respective Q₅, Q₆, Q₇, and Q₈ to provide current flow through the input transistors Q₅, Q₆, Q₇, and Q₈. Additionally, in the example of FIG. 4, the input transistor Q₅ includes an input resistor R_{IN5} that is coupled in series with the base to interconnect the base and the collector of the input transistor Q₅, and the input transistor Q₆ includes an input resistor R_{IN6} that is coupled in series with the base to interconnect the base and the collector of the input transistor Q₆. Similarly, the input transistor Q₇ includes an input resistor R_{IN7} that is coupled in series with the base to interconnect the base and the collector of the input transistor Q₇, and the input transistor Q₈ includes an input resistor R_{IN8} that is coupled in series with the base to interconnect the base and the collector of the input transistor Q₈. Therefore, the diode-connection of the input transistors Q₅, Q₆, Q₇, and Q₈ is via the respective input resistors R_{IN5}, R_{IN6}, R_{IN7}, and R_{IN8}.

Similar to as described previously regarding the example of FIG. 2, based on the input resistors R_{IN5}, R_{IN6}, R_{IN7}, and R_{IN8} being coupled in series with the base of the respective input transistors Q₅, Q₆, Q₇, and Q₈, the reference voltage generator circuit 150 can compensate for errors based on controlling the emitter current Iₑ instead of the collector current I_{c}. For example, a base-emitter voltage V_{be} can be controlled based on the emitter current Iₑ instead of the collector current I_{c}, such as demonstrated in Equations 2-4. Since the error term associated with the base current I_{b} in the calculation of the base-emitter voltage V_{be} can contribute to error effects based on transistor β, base current shot noise, flicker noise, and/or burst noise, the error effects can be substantially mitigated based on controlling the emitter current Iₑ instead of the collector current I_{c} in response to implementing the input resistors R_{IN5}, R_{IN6}, R_{IN7}, and R_{IN8}. Accordingly, the inclusion of the input resistors R_{IN5}, R_{IN6}, R_{IN7}, and R_{IN8} in the reference voltage generator circuit 150 can substantially mitigate low frequency noise in the reference voltage V_{REF}, resulting in a more stable reference voltage V_{REF}.

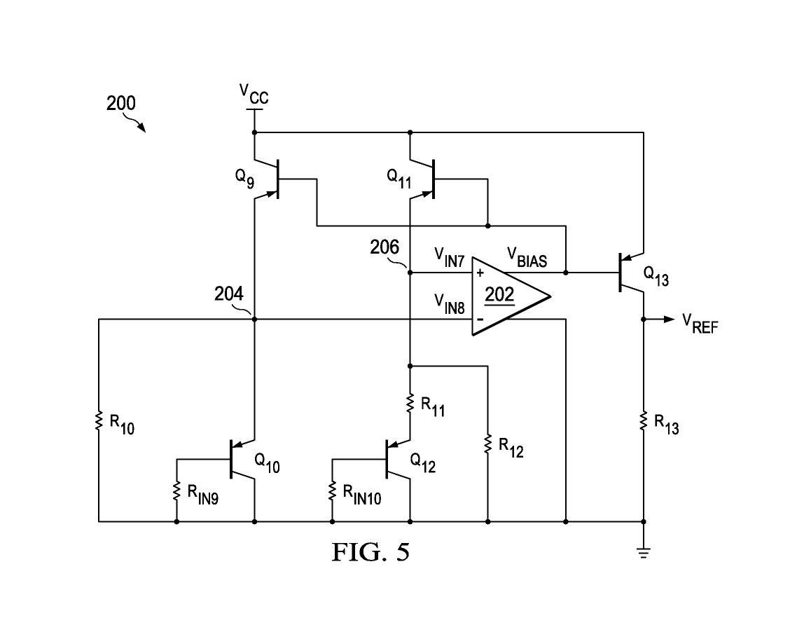

FIG. 5 illustrates yet a further example of a reference voltage generator circuit 200. The reference voltage generator circuit 200 can correspond to the reference voltage generator system 10, and is thus demonstrated as a fourth example of the reference voltage generator system 10.

The reference voltage generator circuit 200 includes an amplifier 202 arranged as an OP-AMP that is configured to generate a voltage V_{BIAS} with reference to a low-voltage rail, demonstrated in the example of FIG. 5 as ground. The amplifier 202 receives a first input voltage V_{IN7} on a node 204 at a non-inverting input and a second input voltage V_{IN8} on a node 206 at an inverting input. The node 204 is arranged between a collector of a transistor Q₉ and an emitter of a first input transistor Q₁₀, as well as a resistor R₁₀ that interconnects the node 204 and the low-voltage rail. The node 206 is arranged between a collector of a transistor Q₁₁ and a resistor R₁₁, with the resistor R₁₁ interconnecting the node 206 and an emitter of a second input transistor Q₁₂, as well as a resistor R₁₂ that interconnects the node 206 and the low-voltage rail. In the example of FIG. 5, the transistors Q₉ and Q₁₁ and the input transistors Q₁₀ and Q₁₂ are each demonstrated in the example of FIG. 5 as PNP-type BJTs. The input transistors Q₁₀ and Q₁₂ each have collectors that are coupled to the low-voltage rail. As an example, the input transistors Q₁₀ and Q₁₂ can be substrate-coupled BJTs, and the input transistors Q₁₀ and Q₁₂ can have sizes that differ with respect to each other to achieve a desired gain of the reference voltage V_{REF}.

The transistors Q₉ and Q₁₁ interconnect a power voltage V_{CC} at an emitter and the respective nodes 204 and 206 at a collector, and are controlled by the bias voltage V_{BIAS} at a respective base. Additionally, the bias voltage V_{BIAS} controls an output transistor Q₁₃ that interconnects the power voltage V_{CC} at an emitter and an output node 208 at a collector. As an example, the output transistor Q₁₃ can be fabricated as a matched component with respect to the transistors Q₉ and Q₁₁. A resistor R₁₃ interconnects the output node 208 and the low-voltage rail, such that the output transistor Q₁₃ generates the reference voltage V_{REF} on the output node 208. Therefore, the input transistor Q₁₀ can set an amplitude of the input voltage V_{IN7} based on the resistance across the input transistor Q₁₀ along with the transistor Q₉. Similarly, the input transistor Q₁₂ can set an amplitude of the input voltage V_{IN8} based on the resistance across the input transistor Q₁₂ along with the resistor R₁₁ and the transistor Q₁₁. Therefore, the amplifier 202 is demonstrated in the example of FIG. 5 in a feedback arrangement based on the control of the transistors Q₉ and Q₁₁ via the bias voltage V_{BIAS} generated by the amplifier. In the example of FIG. 5, the current ratio of the input transistors Q₁₀ and Q₁₂ is set by the transistors Q₉ and Q₁₁ and the V_{be} voltage of the input transistors Q₁₀ and Q₁₂ is converted to current by the resistors R₁₀ and R₁₂. Thus, when the current through the resistor R₁₁ (e.g., (ΔV_{be})/R) is summed with the current through the resistor R₁₂ (e.g., V_{be}/R), the summed current through a resistor of same type (e.g., the resistor R₁₃ in the example of FIG. 5) and through the current mirror transistor Q₁₃ results in the reference voltage V_{REF} being substantially constant with temperature (e.g., based also on the fabrication of the transistors Q₉ and Q₁₁ and the output transistor Q₁₃ as matched components). While the transistors demonstrated in the reference voltage generator system 200 (e.g., the transistors Q₉, Q₁₁, and Q₁₃) are demonstrated as PNP-type BJT transistors, it is to be understood that the reference voltage generator system 200 could instead include other types of transistors, such as P-type metal oxide semiconductor field-effect transistors (MOSFETs).

In the example of FIG. 5, the input transistors Q₁₀ and Q₁₂ are each demonstrated as diode-connected, such that the base of each of the input transistors Q₁₀ and Q₁₂ are coupled to the collector of each of the input transistors Q₁₀ and Q₁₂. Therefore, the input transistors Q₁₀ and Q₁₂ are statically biased to provide a substantially static activation of the respective Q₁₀ and Q₁₂ to provide current flow through the input transistors Q₁₀ and Q₁₂. Additionally, in the example of FIG. 5, the input transistor Q₁₀ includes an input resistor R_{IN9} that is coupled in series with the base to interconnect the base and the collector of the input transistor Q₁₀, and the input transistor Q₁₂ includes an input resistor R_{IN10} that is coupled in series with the base to interconnect the base and the collector of the input transistor Q₁₂. Therefore, the diode-connection of the input transistors Q₁₀ and Q₁₂ is via the respective input resistors R_{IN9} and R_{IN10}.

Similar to as described previously regarding the example of FIG. 2, based on the input resistors R_{IN9} and R_{IN10} being coupled in series with the base of the respective input transistors Q₁₀ and Q₁₂, the reference voltage generator circuit 200 can compensate for errors based on controlling the emitter current Iₑ instead of the collector current I_{c}. For example, a base-emitter voltage V_{be} can be controlled based on the emitter current Iₑ instead of the collector current I_{c}, such as demonstrated in Equations 2-4. Since the error term associated with the base current I_{b} in the calculation of the base-emitter voltage V_{be} can contribute to error effects based on transistor β, base current shot noise, flicker noise, and/or burst noise, the error effects can be substantially mitigated based on controlling the emitter current Iₑ instead of the collector current I_{c} in response to implementing the input resistors R_{IN9} and R_{IN10}. Accordingly, the inclusion of the input resistors R_{IN9} and R_{IN10} in the reference voltage generator circuit 200 can substantially mitigate low frequency noise in the reference voltage V_{REF}, resulting in a more stable reference voltage V_{REF}.

While the systems and principles described herein are with reference to a reference voltage generator (e.g., a bandgap voltage generator), it is to be understood that the inclusion of the resistor in series with the base of the input transistors is not limited to the circuits described herein. For example, any of a variety of other circuits can implement input voltage control of an amplifier in a manner that it is substantially insensitive to temperature variations and which substantially mitigates noise sources, such as shot noise, flicker noise, and/or burst noise. As an example, a temperature sensor can implement an amplifier having input voltages that are controlled via input transistors (e.g., BJT transistors) having series-connected resistors to implement control of a base-emitter voltage V_{be} based on the emitter current Iₑ instead of the collector current I_{c}, such as demonstrated in Equations 2-4. Therefore, the circuits described herein can be implemented for a variety of applications.

What have been described above are examples of the invention. It is, of course, not possible to describe every conceivable combination of components or method for purposes of describing the invention, but one of ordinary skill in the art will recognize that many further combinations and permutations of the invention are possible. As used herein, the term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements. Accordingly, the invention is intended to embrace all such alterations, modifications, and variations that fall within the scope of this application, including the appended claims.

What is claimed is:

1. An reference voltage generator system comprising:
an amplifier configured to generate a reference voltage based on a respective input voltage provided at each of at least one input of the amplifier; and
at least one input transistor that is coupled to the at least one input of the amplifier and is statically-biased to conduct a current to set an amplitude of the respective input voltage provided at each of the at least one input of the amplifier, each of the at least one input transistor comprising an input terminal that is coupled in series with an input resistor.

2. The system of claim 1, wherein each of the at least one input transistor is statically-biased to conduct the current based on being diode-connected, such that the input resistor interconnects the input terminal and a second terminal of each respective one of the at least one input transistor.

3. The system of claim 1, wherein each of the at least one input transistor is configured as a bipolar junction transistor (BJT) comprising a base that is coupled in series with the input resistor.

4. The system of claim 3, wherein the BJT is a substrate-coupled BJT.

5. The system of claim 1, wherein the at least one input transistor comprises:
a first input transistor comprising a first terminal that is coupled to a low-voltage rail and a second terminal that is coupled to a first input of the amplifier; and
a second input transistor comprising a first terminal that is coupled to the low-voltage rail and a second terminal that is coupled to a second input of the amplifier via a resistor.

6. The system of claim 5, wherein the resistor is a first resistor, the system further comprising:
a second resistor interconnecting the second input of the amplifier and the reference voltage, such that the first and second resistors form a voltage-divider; and
a third resistor interconnecting the first input of the amplifier and the reference voltage.

7. The system of claim 1, wherein the at least one input transistor comprises:
a first pair of input transistors that are coupled in series with respect to each other to conduct a first current to set an amplitude of a first input voltage provided to a first input of the amplifier, each of the first pair of input transistors comprising an input terminal that is coupled in series with a respective input resistor; and
a second pair of input transistors that are coupled in series with respect to each other to conduct a second current to set an amplitude of a second input voltage provided to a second input of the amplifier, each of the second pair of input transistors comprising an input terminal that is coupled in series with another respective input resistor.

8. The system of claim 1, further comprising:
an output transistor that is controlled by an output of the amplifier and which interconnects a power voltage and an output node on which the reference voltage is generated based on an output current flowing through the first output transistor; and
at least one feedback transistor that is controlled by the output of the amplifier and which interconnects the power voltage and the respective at least one input of the amplifier to provide the input voltage at the respective at least one input of the amplifier in a feedback arrangement.

9. The system of claim 1, wherein a resistance value of the input resistor is selected based on an error term of a current associated with the input terminal of the respective at least one input transistor, the current associated with the input terminal being associated with an activation voltage of the at least one input transistor to set the amplitude of the respective input voltage.

10. The system of claim 9, wherein each of the at least one input transistor is configured as a bipolar junction transistor (BJT) comprising a base that is coupled in series with the input resistor, wherein the resistance value R_{b} is set to achieve a predetermined emitter-base voltage of the at least one input transistor based on:
$${R}_{b} = \frac{- {V}_{T} ln [ 1 - \frac{{I}_{b}}{{I}_{e}} ]}{{I}_{b}} ;$$
where:
V_{T} is a thermal voltage associated with the at least one input transistor;
I_{b} is a base current associated with the at least one input transistor; and
Iₑ is an emitter current associated with the at least one input transistor.

11. The system of claim 1, further comprising at least one feedback circuit component associated with a feedback arrangement of the amplifier to set the amplitude of the at least one input voltage, wherein the at least one input transistor is configured to conduct a proportional-to-absolute-temperature (PTAT) current, and wherein the at least one feedback circuit component is fabricated as a matched component of the at least one input resistor or of an output transistor that is controlled via the amplifier, such that the reference voltage is approximately insensitive to temperature variation.

12. A circuit comprising:
an amplifier configured to generate a reference voltage based on a respective input voltage provided at each of at least one input of the amplifier; and
at least one input transistor that is coupled to the at least one input of the amplifier and is statically-biased to conduct a current to set an amplitude of the respective input voltage provided at each of the at least one input of the amplifier, each of the at least one input transistor comprising an input terminal that is coupled in series with an input resistor, the input resistor having a resistance value that is selected based on an error term of a current associated with the input terminal of the respective at least one transistor, the current associated with the input terminal being associated with an activation voltage of the at least one transistor to set the amplitude of the respective input voltage.

13. The circuit of claim 12, wherein each of the at least one input transistor is statically-biased to conduct the current based on being diode-connected, such that the input resistor interconnects the input terminal and a second terminal of each respective one of the at least one input transistor.

14. The circuit of claim 12, wherein each of the at least one input transistor is configured as a substrate-coupled bipolar junction transistor (BJT) comprising a base that is coupled in series with the input resistor.

15. The circuit of claim 12, wherein each of the at least one input transistor is configured as a bipolar junction transistor (BJT) comprising a base that is coupled in series with the input resistor, wherein the resistance value R_{b} is set to achieve a predetermined emitter-base voltage of the at least one input transistor based on:
$${R}_{b} = \frac{- {V}_{T} ln [ 1 - \frac{{I}_{b}}{{I}_{e}} ]}{{I}_{b}} ;$$
where:
V_{T} is a thermal voltage associated with the at least one input transistor;
I_{b} is a base current associated with the at least one input transistor; and
Iₑ is an emitter current associated with the at least one input transistor.

16. An reference voltage generator system comprising:
an amplifier configured to generate a reference voltage based on a respective input voltage provided at each of at least one input of the amplifier;
at least one input bipolar junction transistor (BJT) that is coupled to the at least one input of the amplifier and is statically-biased to conduct a proportional-to-absolute-temperature (PTAT) current to set an amplitude of the respective input voltage provided at each of the at least one input of the amplifier, each of the at least one input BJT comprising an input resistor interconnecting a base and a collector of the respective at least one input BJT; and
at least one feedback circuit component associated with a feedback arrangement of the amplifier to set the amplitude of the at least one input voltage, the at least one feedback circuit component being fabricated as a matched component of the at least one input resistor or of an output transistor that is controlled via the amplifier, such that the reference voltage is approximately insensitive to temperature variation.

17. The system of claim 16, wherein the at least one input transistor comprises:
a first input BJT comprising a first terminal that is coupled to a low-voltage rail and a second terminal that is coupled to a first input of the amplifier; and
a second input BJT comprising a first terminal that is coupled to the low-voltage rail and a second terminal that is coupled to a second input of the amplifier via a resistor.

18. The system of claim 16, wherein the at least one input transistor comprises:
a first pair of input BJTs that are coupled in series with respect to each other to conduct a first current to set an amplitude of a first input voltage provided to a first input of the amplifier, each of the first pair of input BJTs comprising an input resistor interconnecting a base and a collector of each of the respective first pair of input BJTs; and
a second pair of input transistors that are coupled in series with respect to each other to conduct a second current to set an amplitude of a second input voltage provided to a second input of the amplifier, each of the second pair of input BJTs comprising an input resistor interconnecting a base and a collector of each of the respective second pair of input BJTs.

19. The system of claim 17, further comprising:
an output transistor that is controlled by an output of the amplifier and which interconnects a power voltage and an output node on which the reference voltage is generated based on an output current flowing through the first output transistor; and
at least one feedback transistor that is controlled by the output of the amplifier and which interconnects the power voltage and the respective at least one input of the amplifier to provide the input voltage at the respective at least one input of the amplifier in a feedback arrangement.

20. The system of claim 17, wherein a resistance value of the input resistor is selected based on an error term of a current associated with the input terminal of the respective at least one input BJT to set an activation voltage of the at least one input BJT to set the amplitude of the respective input voltage.
